(19) United States
(12) Patent Application Publication
(10) Pub. No.: US 2004/0141823 A1
(43) Pub. Date: Jul. 22, 2004

(54) Precision headstock with controlled axes and automatic change of the eletrospindles

(76) Inventor: Renato Padovani, Rancho Viejo, TX (US)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/477,551

(22) PCT Filed: May 9, 2002
(86) PCT No.: PCT/IB02/01565

(30) Foreign Application Priority Data
May 11, 2001 (IT) BA01A000022

(51) Int. Cl. B23C 1/00

(52) U.S. Cl. 409/231

(57) ABSTRACT

Precision headstock (1) with controlled axis characterized by the possibility of automatic changes of the electrospindles (9-12). Thanks to this peculiarity the machine has the following advantages in comparison to similar products: high working speeds, different behavior and conformation of the chip, reduction of the cut forces, reduction of the working time, increase of the dimensional precision of the piece, possibility to work thin and vibration sensitive pieces.

### TECHNICAL FIELD

The present invention relates to a precision headstock with controlled axes and automatic change of the electrospindles. Machine moulding (metals, plastic material, wood) comprises two different product lines: finished and semifinshed products. The machines used are mainly millers and lathes, in a wide range of realizations, from the single machine to production chain. The essential features of these machines required by the modern market are: working at high speed, high productivity, maximum precision and, naturally, cost reduction. To satisfy these requirements, every single machine should perform the greatest possible number of operations on the worked piece, avoiding further positionings, long tooling and dead times: ideally, the piece should be transformed from raw material into finisched piece. In the last years, a remarkable increase in industrial automation has been seen as general trend. The Headstock has been transformed from canonical forms (heads with one or two axes, with 45° degrees rotations), reaching high sizes and characteristics; at the same time, the need of headstocks with different size, shape, power and capability has increased accordingly. A big drawback of today's technique is due to the need to cover a wide range of applications with a unified system of spindle headstocks. This strongly limits the machine flexibility: from one side, high speed machining is required to get different shape and behavior of the chip, from the other side, in the case of lower speed workings, the same spindles would have an insufficient power.

### DISCLOSURE OF THE INVENTION

The present invention solves the technical problems above mentioned being a precision headstock with controlled axes characterized by the automatic change of the electrospindles. Thanks to this feature the machine provides the following advantages in comparison to similar products: high working speed up to 20 times higher than the actual standards, which cause a different behaviour and conformation of the chip; reduction of cutting force and increase of the chip volume per second with consequent working time reduction; increase of the dimensional precision and improved surface finish (the heat generated by cutting is carried away with the chip); efficient machining of thin or buttle pieces.

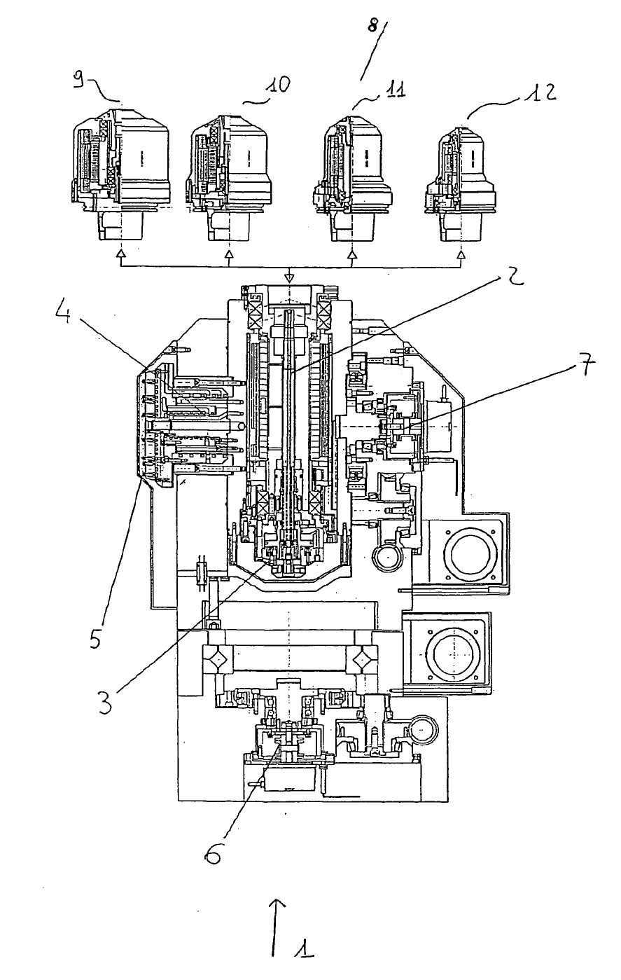

These and other advantages will be pointed out in the detailed description of the invention that will refer to the table 1/1 in which a front view scheme (FIG. 1) is shown. It is exemplifying and not restrictive.

### WAY OF CARING OUT THE INVENTION

With reference to FIG. 1 with (1) the precision headstock according to the invention is shown. It comprises the following main sub-systems:

Electrospindle with main spindle (2) inserted in the central room. The spindle shaft is assembled on two couples of high precision bearings, suitable for high speeds; hybrid ceramic ball bearings; the bearing preload is set up through a servoassisted hydraulic piston. Decreasing the speed, the bearing preload is increased to stiffen the spindle and viceversa, when the speed is increased, the bearing preload decreases. The back bearings of the spindle shaft are mounted in a thin cage with steel spheres, to favour the sliding during the warm-up and consequent dilatation of the spindle. The spindle power is about 20 KW at 6.000 rpm.

Tool and electrospindles locking system/arrangement (3), realized with an oil/air system. The hydraulic piston acts on the rod carrying the locking plier; another air-controlled piston pushes a series of steel balls inside the rod to ensure the tool locking. Thanks to a series of Belleville washer, the same cylinder is released allowing in this way the spindle rotation. All the locking, unlocking and release movements of the cylinder are controlled by inductive sensors communicating with the electronic control unit. The same system is used to lock automatically the electrospindles during their change.

Hydraulic rotating distributor (4), made of concentric passages to provide more uses in a limited space. The distributor is crossed by all the cooling and pressured fluids and the necessary air for the main and the auxiliary spindles. All the distributor feeding channels are separated by low friction gaskets, to avoid the mixing between liquids and air. All passages/sections are made inside the walls, avoiding pipes, which would be a problem, considering the high number of uses.

Electric rotating distributor (5). It can be realized in the standard way by means of preload springs that push tracks against contact. The track plate rotates together with the central room, while the contacts plate is fixed with respect to the headstock structure. The position and computation electronic signals are transmitted by fiber optic data bus. This technology allows high speed and noise-free transmissions, ensuring reliability and high precision. According to a second preferential realization, the transmission can be realized through a suitable electromagnetic coupling. This allows a fill decoupling of the mechanical and electric parts, avoiding problems of wear, insufficient contact, oxidation and noise on the signals. The signal transmission principle can be schematized as follows: energy transfer through electromagnetic coupling on the headstock rotating axes, from the driving towards the electrospindles; signals transfer through electromagnetic coupling, on a parallel channel from the spindle and/or from the electrospindles towards the control; use of optic fiber for the transfer of the logical signals on the predetermined channels and distribution inside the headstock.

Transmission axes “B” and “A.” (6), (7). The axes are moved by brushless motors. The transmission ratio of the engine to the moved part is very high to provide a torque high enough to perform the job. A couple of pulleys between the engine and the endless screws assures the axes movement. Each axe is controlled by an encoder, directly fixed on the mobile part; it avoids any clearance between the mobile part and the encoder. For each axe a hydraulic locking device is inserted when the axe has to perform long-lasting operations with steady axe.

Auxiliary electrospindles (8). They are complete and independent from the main spindle. They are characterized by the fact that they can be mounted on the principal spindle, by an automatic tool-changer. Once inserted in the main spindle cone, it will be automatically fed with the statoric cooling liquid, the power feeding, the safety signals input and the air for the tool cooling, through the tool spindle. The main spindle will be mechanically stopped by the auxiliary electrospindle, which works independently of the main spindle, at the tated speed and power of the electrospindle. At the end of the job, it will be automatically replaced by another electrospindle with different speed and power, or by the main spindle, automatically restoring the headstock standard situation. Some practical examples of auxiliary electrospindles are described.

Electrospindle with 15 KW at 16.000 rpm (9), particularly suitable for high speed using insert tools made of suitable materials (both to the workings and to the piece); electrospindle with 10 KW at 20.000 rpm (10) suitable for semirough and semifinished machinings using insert and integral tools power and maximum rotational speed make this spindle particularly suitable for flexible workings (rough and finished machinings with the same spindle); electrospindle with 4,5 KW at 40.000 rpm (11), particularly suitable for finishing operations. The reachable rotational speed allows finishings with high speeds of the machine axis; electrospindle with 2,8 KW at 60.000 rpm (12) particularly suitable for operations on fittings and small surfaces. The very high rotational speed allows to get high speed of workings and elevated results of finishing.

1) Precision headstock with controlled axes comprising a main electrospindle and a number of auxiliary electrospindles, driving means, control means, hydraulic and electrical distributors, electrospindle locking arrangement, characterized by the fact that, at least on the controlled axis (6) and (7) an automatic change of the electrospindles takes place.

2) Precision headstock according to the claim 1 characterized by the fact that said automatic change of the electrospindles, made by a tool-changer, allows the auxiliary electrospindle to take all the necessary feedings to its operation (statoric cooling liquid, power feeding, safety signals input and air for the tool cooling) and to stop mechanically the main spindle so that to work at its rated speed and power, in an independent way of said main spindle.

3) Precision headstock according to the claim 2, characterised in that said electrospindle with the main spindle is assembled on two couples of high precision hybrid ceramic ball bearings, suitable for high speeds, and the bearing preload is set up through a servoassisted hydraulic piston.

4) Precision headstock according to the claim 2 or 3, characterised in that said tool and electrospindles locking arrangement is realized with oil and/or air system.

5) Precision headstock according to one of the claims from 2 to 4, characterised in that said hydraulic distribution means consist of a hydraulic rotating distributor, made of concentric passages, with feeding channels, which are separated by low friction gaskets, and with passages inside the walls.

6) Precision headstock according to one of the claims from 2 to 5, characterised in that said electrical distributors are realized by means of preloaded spring that push tracks against contacts.

7) Precision headstock according to one of the claims from 2 to 5, characterised in that said electrical distributors are realized by means of electromagnetic coupling and the signal transmission principle consists of the energy transfer, through electromagnetic coupling, on the rotating axis of the headstock and the signals transfer, also through electromagnetic coupling, on a parallel channel.

8) Precision headstock according to one or more of the previous claims, characterised in that the electrospindles axes are moved by brushless motor, at high transmission ratio; each of them is controlled by an encoder, directly fixed on the mobile part; each of them can be hydraulically locked.
